(19) United States
(12) Patent Application Publication
(10) Pub. No.: US 2021/0237932 A1
(43) Pub. Date: Aug. 5, 2021

(54) Centric Interlocking System

(71) Applicant: Robert Sean Croker, Christchurch (NZ)

(72) Inventor: Robert Sean Croker, Christchurch (NZ)

(21) Appl. No.: 17/268,618

(22) PCT Filed: Aug. 29, 2019
(86) PCT No.: PCT/NZ2019/050113

§ 371 Date: Feb. 16, 2021

(30) Foreign Application Priority Data
Aug. 29, 2018 (NZ) 745776

(51) Int. Cl. B65D 21/02; A47J 37/10; A47B 87/02

(52) U.S. Cl. CPC B65D 21/0231; F21V 21/03; A47B 87/0215; A47J 37/108

(57) ABSTRACT

Disclosed herein is a detachable interlocking system for securing at least two articles together, the interlocking system including: a first interfacing portion; ii. a second interfacing portion; iii. the first and second interfacing portions being in complementary arrangement configured to engage with one another in a first engaged position and are moveable to a second interlocked position; iv. locking means to interlock the first and second interfacing portions together; v. reciprocating means to receive and accommodate the locking means; wherein movement from the first engaged position to the second interlocked position engages the locking means to interlock the first and second interfacing portions together.

### FIELD OF INVENTION

The invention relates to an interlocking system. In particular, the invention relates to a detachable interlocking system between at least two articles.

### BACKGROUND TO THE INVENTION

Containers, such as tin containers, are commonly used in industry to store a variety of foodstuffs. The containers are sealed in a sterile environment and provide suitable and convenient ‘all in one’ storage and packaging solution for manufacturers and suppliers to sell their products. Such containers provide comfort and security to the consumer that the product that they have purchased is securely sealed; with the contents remaining safe to consume until they decide to open the container. Opening of the containers is relatively straight forward for a consumer by use of common household utensils such as a can opener. Alternatively, some containers now include ‘easy-peel’ openings, and the like, which allow quick and easy access to the contents of the containers without using any utensils.

Traditionally such containers are singular containers, independent of one another, and sold separately. The containers are generally cylindrical containers and include top and bottom flanges which allow a number of containers to be nested or stacked on top of one another.

Disadvantages with such containers arise due to the separate and individual nature of the containers, a manufacturer or seller is unable to combine or promote groups of products together. Instead, the seller is forced to individually stack each product separately at different locations.

Previous attempts to address this problem include using further packaging, usually in the form of a plastic wrap, to group or combine multiple containers together. However, this requires an additional time-consuming packaging step to the manufacturer and incurs undesirable costs during production.

There are also reusable locking storage containers having threaded lids which connect to the bottom of upper containers via keyed locking. The action required to open such containers is the same action that is required to accomplish the locking. This arrangement has the disadvantage of unintentional decoupling of lid to container when used in a rapid manner. The reusable containers in every instance, require that consumer fill the container with product, and are not sold with a factory seal preserving ‘ready to eat’ or ‘ready to heat and eat’ contents.

Further, reusable locking containers are not designed to connect to surfaces. They require greater cognitive alignment due to the translucence of the material and the placement of protrusions and recesses. Additionally, the curved surfaces of protrusions and the drastic tapering at the base affect the container's centre of gravity, making for less stable misaligned stacking and general vertical stability on a planar surface.

### OBJECT OF THE INVENTION

It is an object of the invention to provide a detachable interlocking system that addresses the foregoing problems.

Alternatively, it is an object of the invention to at least provide the public with a useful choice.

### SUMMARY OF THE INVENTION

According to a first aspect of the invention, there is provided a detachable interlocking system for securing at least two articles together, the interlocking system including:
a first interfacing portion;
a second interfacing portion;
locking means to interlock the first and second interfacing portions together;
reciprocating means to receive and accommodate the locking means;
the first and second interfacing portions being in complementary arrangement,
configured to engage with one another in a first engaged position and are moveable to a second interlocked position;

wherein movement from the first engaged position to the second interlocked position engages the locking means to interlock the first and second interfacing portions together.

Preferably the first and second interfacing portions are included on either the same article or two different articles.

Preferably the first and second interfacing portions each respectively include a first and second substantially circular axial projection extending out from at least one external surface from the article.

Preferably the first and second interfacing portions each respectively includes an attachment portion to retrospectively incorporate and apply the interlocking system on to existing articles.

Preferably the attachment portion includes a mounting base for attachment to an existing article.

Preferably the mounting base conforms to an external surface of the article.

Preferably said substantially circular axial projection is composed of a pliable material or the like.

Preferably the size of one interfacing portion is larger than the other interfacing portion to allow the first and second interfacing portions to be nestable within one another.

Preferably the reciprocating means is configured to complimentarily receive the locking means in the first engaged position.

Preferably the locking means is located on the first interfacing portion.

Preferably the locking means includes at least one locking protrusion inset from the substantially circular axial projection of the first interfacing portion.

Preferably the reciprocating means is located on the second interfacing portion.

Preferably the reciprocating means includes at least one complementary receiving protrusion inset from the substantially circular axial projection of the second interfacing portion.

Preferably the movement from the first engaged position to the second interlocked position is by way of rotational movement of the first and second interfacing portions in relative opposing axial directions.

Preferably the locking means is engaged by movement to the second interlocked position by way of the locking protrusion frictionally abutting a face of the substantially circular axial projection of the second interfacing portion.

Preferably the movement from the first engaged position to the second interlocked position is by way of rotational movement in either clockwise or anti-clockwise directions.

Preferably the locking protrusion frictionally abutting said face of the interfacing portion results in the larger interfacing portion flexing when engaged in the second interlocked position.

Preferably the flexing of the larger interfacing portion results in a concentration of force on the smaller interfacing portion to restrict movement in the second interlocked position.

Preferably the locking means includes at least three locking protrusions located along the substantially circular axial projection of the first interfacing portion.

Preferably said locking protrusions are equally spaced along the substantially circular axial projection of the first interfacing portion.

Preferably the reciprocating means includes at least three complementary receiving protrusions located on the substantially circular axial projection of the second interfacing portion.

Preferably said receiving protrusions are equally spaced along the substantially circular axial projection of the second interfacing portion and correspond to the positioning of the locking protrusions.

Preferably the interlocking system further includes abutment means to provide an indicator in the form of haptic feedback to the user that the interlocking system has been optimally interlocked in the second interlocked position.

Preferably the abutment means includes at least one abutment member and/or a knurled surface.

Preferably the abutment member is a prominence located along the substantially circular axial projection of the second interfacing portion.

Preferably the knurled surface is located along either the first or second substantially circular axial projection.

Preferably the interlocking system further includes a visual aid to allow the user to recognise the articles are in the first engaged or second interlocked position from a distance.

Preferably the visual aid includes markings, or the like along the first and/or second interfacing portions and/or their respective articles.

Preferably the articles are selected from containers, household items, fixtures, equipment, kit set furniture and/or combinations thereof.

In a second aspect of the invention, there is provided a detachable interlocking container system for coupling at least two containers together, the interlocking container system including:
a container having a top interfacing portion and a bottom interfacing portion;
the top and bottom interfacing portions being in a complementary arrangement configured to allow at least two containers to nest or stack on top of one another in a first engaged position;
locking means located on either the top or bottom interfacing portion, and
complementary reciprocating means located on an opposite interfacing portion of the locking means;
the reciprocating means is configured to receive and accommodate the locking means in the first engaged position;

wherein rotational movement from the first engaged position to a second interlocked position engages the locking means to securely couple the containers to one another.

Preferably the top and bottom interfacing portions each respectively include a top and bottom substantially circular axial projection extending out from at least one external surface of the container.

Preferably said top and bottom substantially circular axial projection is composed of a pliable material or the like.

Preferably the bottom interfacing portion is of a size larger than the top interfacing portion to allow the top and bottom interfacing portions to be nestable within one another in the first engaged position.

Preferably the locking means are located on the bottom interfacing portion.

Preferably the locking means includes at least one locking protrusion inset from the bottom substantially circular axial projection of the bottom interfacing portion.

Preferably the locking means includes three locking protrusions located on the substantially circular axial projection of the bottom interfacing portion.

Preferably the three locking protrusions are equally spaced along the bottom substantially circular axial projection of the bottom interfacing portion.

Preferably the reciprocating means are located on the top interfacing portion.

Preferably the reciprocating means includes at least one complementary receiving protrusion inset from the substantially circular axial projection of the top interfacing portion.

Preferably the reciprocating means includes three complementary receiving protrusions located on the top substantially circular axial projection of the top interfacing portion.

Preferably the three receiving protrusions are equally spaced along the top substantially circular axial projection of the top interfacing portion and correspond to the positioning of the locking protrusions.

Preferably the movement from the first engaged position to the second interlocked position is by way of rotational movement of the containers and their respective interfacing portions in relative opposing axial directions.

Preferably the locking means is engaged by movement to the second interlocked position by way of the locking protrusion frictionally abutting a face of the substantially circular axial projection of the top interfacing portion.

Preferably the movement from the first engaged position to the second interlocked position is by way of rotational movement in either clockwise or anti-clockwise directions.

Preferably the locking protrusion frictionally abutting said face of the interfacing portion results in the larger interfacing portion flexing when engaged in the second interlocked position.

Preferably the flexing of the larger interfacing portion results in a concentration of force on the smaller interfacing portion to restrict movement in the second interlocked position.

Preferably the locking means includes at least three locking protrusions located along the bottom substantially circular axial projection of the bottom interfacing portion.

Preferably said locking protrusions are equally spaced along the substantially circular axial projection of the bottom interfacing portion.

Preferably the reciprocating means includes at least three complementary receiving protrusions located along the top substantially circular axial projection of the top interfacing portion.

Preferably said receiving protrusions are equally spaced along the substantially circular axial projection of the top interfacing portion.

Preferably the interlocking container system further includes abutment means to provide an indicator in the form of haptic feedback to the user that the interlocking system has been optimally interlocked in the second position.

Preferably the abutment means includes at least one abutment member and/or a knurled surface.

Preferably the abutment member is a prominence located along the substantially circular axial projection of the top interfacing portion.

Preferably the knurled surface is located along either the top or bottom substantially circular axial projection.

Preferably the containers of the interlocking container system includes assurance means in the form of an edible adhesive, or the like to provide assurance to a user the integrity of the contents in the container has not been tampered with or compromised.

Preferably the interlocking container system further includes a visual aid to allow the user to recognise the articles are in the first engaged or second interlocked position from a distance.

Preferably the visual aid includes markings or the like, along the first and/or second interfacing portions and/or their respective articles.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1A: is a top cross-sectional aerial view of the interlocking system of the present invention in a nested or stacked position (i.e. the first engaged position);

FIG. 1B: is a sectional isometric view of the interlocking system of the present invention in a nested or stacked position (i.e. the first engaged position);

FIG. 2A: is a top cross-sectional aerial view of the interlocking system of the present invention in an interlocked position (i.e. the second interlocked position);

FIG. 2B: is a sectional isometric view of the interlocking system of the present invention in an interlocked position (i.e. the second interlocked position);

FIG. 3: is a top aerial view of a first interfacing portion of the interlocking system of the invention;

FIG. 4: is a bottom aerial view of a second interfacing portion of the interlocking system of the invention;

FIG. 5A: is a further top cross-sectional aerial view of interlocking system of the present invention in an interlocked position including abutment members;

FIG. 5B: is a sectional isometric view of a second interfacing portion of the present invention including abutment members as shown in FIG. 5A;

FIG. 6A: is a further top cross-sectional aerial view of interlocking system of the present invention in an interlocked position showcasing an alternative position for abutment members;

FIG. 6B: is a sectional isometric view of a second interfacing portion of the present invention including an alternative position for abutment members as shown in FIG. 6A;

FIG. 7: is a sectional isometric view of a first interfacing portion of the present invention including a knurled surface.

FIG. 8A: is a top isometric view of a recessed flanged attachment portion including an interfacing portion of the present invention.

FIG. 8B: is a top isometric view of a surface mount flanged attachment portion including an interfacing portion of the present invention.

FIG. 8C: is a top isometric view of a projected flanged attachment portion including an interfacing portion of the present invention.

FIG. 9: is a top isometric view of an encompassing attachment portion including external guard projection and an interfacing portion of the present invention.

FIG. 10: is a top isometric view of a surface mount attachment portion including an interfacing portion of the present invention.

FIG. 11A: is a top view of the interlocking system of the present invention being applied to frying pans in the first engaged position;

FIG. 11B: is a top view of the interlocking system of the present invention being applied to frying pans in the second interlocked position;

FIG. 12A: is an aerial view of a second interlocking portion of the present invention being applied to a light fixture;

FIG. 12B: is a top sectional isometric view of a first interlocking portion of the present invention being applied to a light fixture;

FIG. 12C: is a side cross-sectional view of the interlocking system of the present invention being applied to a light fixture;

FIG. 12D: is an isometric view of an assembly drawing of the arrangement of electrical components in use with the interlocking system of the present invention in a light fixture application.

FIG. 13A: is a front view of the interlocking system of the present invention being applied to table;

FIG. 13B: is a front view of the interlocking system of the present invention being applied to vertical shelving;

FIG. 13C: is a front view of the interlocking system of the present invention being applied to horizontal shelving;

FIG. 13D: is a front view of the interlocking system of the present invention being applied to a desk;

FIG. 14: is a top cross-sectional aerial view of an alternative embodiment of the interlocking system of the present invention in a nested or stacked position (i.e. the first engaged position);

FIG. 15: is a top cross-sectional aerial view of an alternative embodiment of the interlocking system of the present invention in an interlocked position (i.e. the second interlocked position);

FIG. 16: is a bottom aerial view of a second interfacing portion of an alternative embodiment of the interlocking system of the invention;

FIG. 17: is a top aerial view of a first interfacing portion of an alternative embodiment of the interlocking system of the invention;

FIG. 18: is a top cross-sectional aerial view of an alternative embodiment of the interlocking system of the present invention in a nested or stacked position (i.e. the first engaged position);

FIG. 19A: is a top cross-sectional aerial view of an alternative embodiment of the interlocking system of the present invention in an interlocked position (i.e. a second interlocked position);

FIG. 19B: is a top cross-sectional aerial view of an alternative embodiment of the interlocking system of the present invention in an interlocked position (i.e. a second interlocked position);

FIG. 20: is a bottom aerial view of a second interfacing portion of an alternative embodiment of the interlocking system of the present invention; and

FIG. 21: is a top aerial view of a first interfacing portion of an alternative embodiment of the interlocking system of the present invention;

### BRIEF DESCRIPTION OF PREFERRED EMBODIMENTS OF THE INVENTION

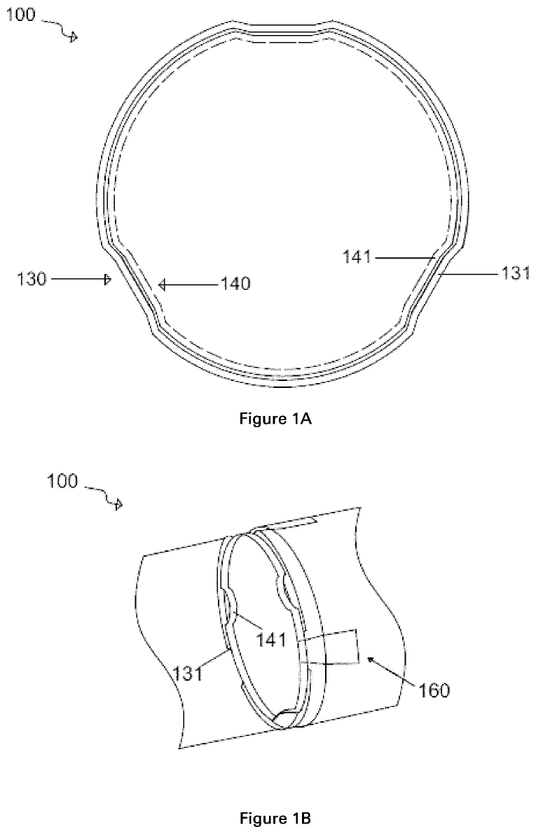

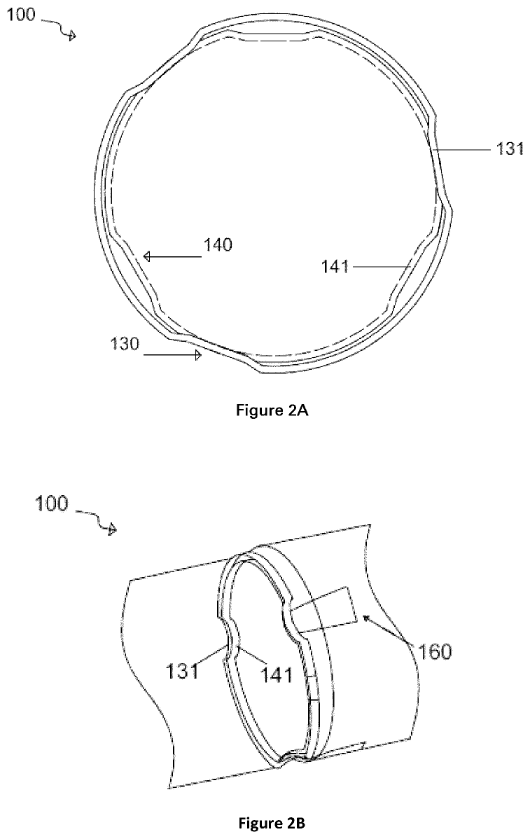

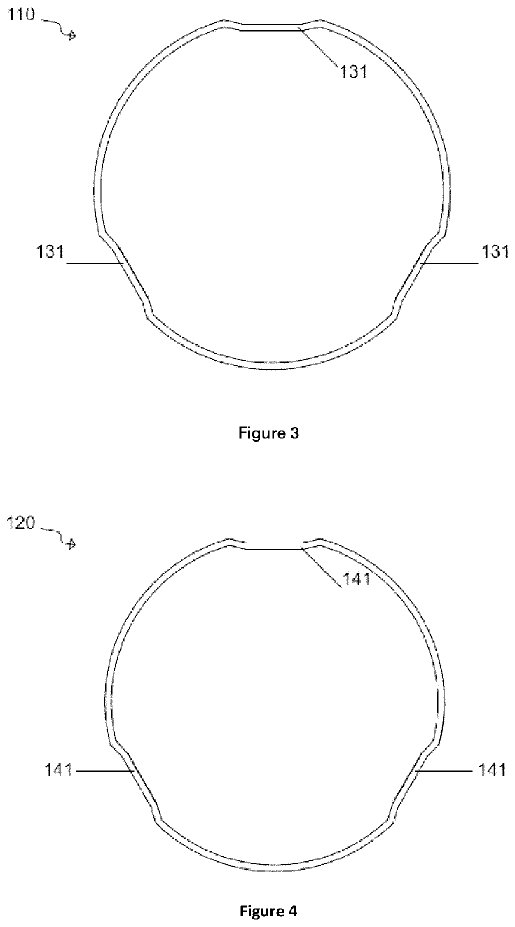

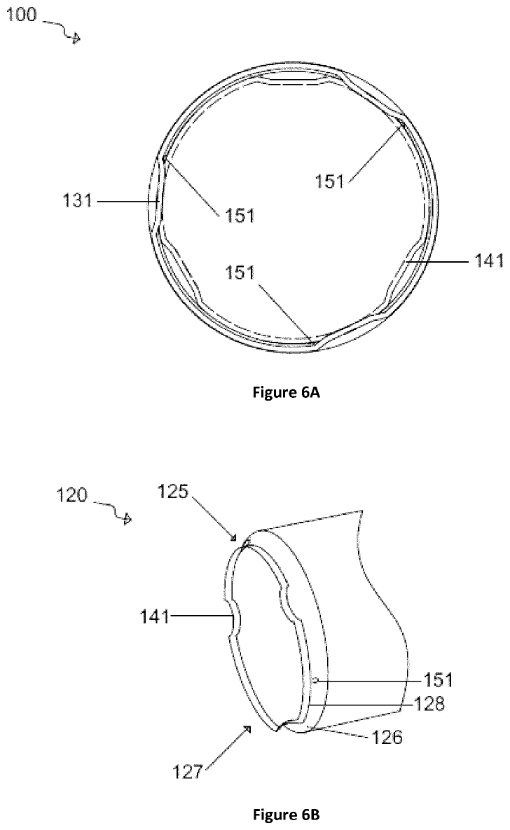

With reference to FIGS. 1A-7 which shows the various components of a detachable interlocking system (100) of the present invention, the interlocking system is configured to detachably secure at least two articles to one another, the interlocking system includes a first interfacing portion (110) located on a first article (not shown) and a second interfacing portion (120) which can be located on either the same first article or a second article (not shown). The first and second interfacing portions (110, 120) are configured to complement one another and receive each other such that the first and second articles have a nestable or stackable arrangement.

It will be appreciated that where the first (110) and second (120) interfacing portions are located on the same article, that the interlocking system of the present invention is configured to be used with at least two separate articles in order to interlock them to one another.

The first and second interfacing portions (110, 120) are able to move from a first engaged position to a second interlocked position. Movement from the first engaged position to the second interlocked position engages the locking means (130) to interlock the first and second interfacing portions (110, 120) with one another. Movement between these two positions can be done by rotation/twisting of adjacent articles in either direction, i.e. clockwise or anti-clockwise, providing said movement occurs in relative opposing axial directions. Further continued movement of the articles in the same respective direction may disengage the locking means and release the articles to the first engaged position. Alternatively, disengaging the locking means can also be done by movement in the opposing direction to that which is used to move to the second engagement position.

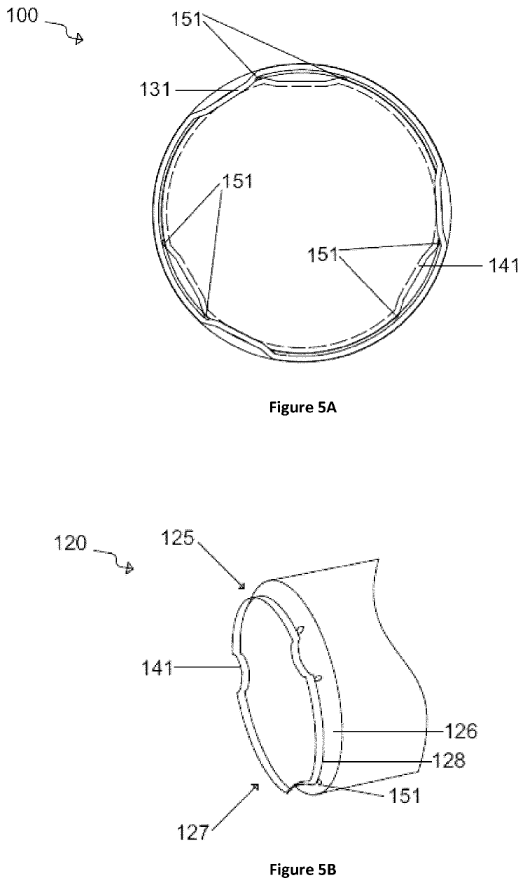

The first and second interfacing portions (110, 120) each include a corresponding first and second axial projection (115, 125) as shown in FIGS. 5B, 6B and 7, extending out from at least one external face of the respective article (not shown). The axial projections (115, 125) are substantially circular in shape, with the circumference of either the first or second axial projection differing in size slightly to the corresponding axial projection of the other article in order to engage with one another in a nestable or stackable arrangement.

The first axial projection (115) comprises of a substantially circular member (117), the second axial projection (125) comprises of a cylindrical taper (126) and a substantially circular member (127) having with a functional lip (128). When the first or second interfacing portion (110, 120) is not in use; it will be appreciated that the interfacing portions (110, 120) provides stability through a low centre of gravity when the article is in flush contact on a planar surface and allows the respective articles to sit without any further aides.

In a preferred embodiment, the first and second interfacing portions (110, 120) are included on the same article, preferably at or near opposite ends to one another to allow an identical or separate article to be interlocked with one another.

The interlocking system (100) includes locking means (130) located on the first axial projection (115) of the first interfacing portion (110). The locking means (130) includes locking protrusions (131), which is inset (that is, it extends inwardly or internally) along the substantially circular member (117) of the first axial projection (115).

Reciprocating means (140) is also included on the interlocking system (100) and is located on the second axial projection (125) of the second interfacing portion (120). The reciprocating means (140) is configured to receive and accommodate the locking means (130) in the first engaged position.

The reciprocating means (140) is included in the form of complimentary receiving protrusions (141), which is inset (that is, it extends inwardly or internally) along the circular member (127) between the cylindrical taper (126) and the functional lip (128) of the second axial projection (125).

As shown in FIGS. 1A & 1B, the respective locking and receiving protrusions (131, 141) are complimentary to one another when in the first engaged position and allow two or more articles to be nested or stacked on top of one another in this position.

Due to the configuration of the locking and receiving protrusions (131, 141) on the respective locking and reciprocating means (130, 140), it will be appreciated that the first and second interfacing portions (110, 120) on the two articles can only be nested or stacked together in a specific arrangement when in the first engaged position. That is, the receiving protrusions (141) will need to be aligned with the locking protrusions (131) in order to allow the first and second interfacing portions (110, 120) to receive one another in a nested or stacked arrangement. This feature provides advantages as it allows a user to determine if the articles have been stacked together correctly and whether the articles can then be moved to the second interlocked position.

As previously described, the first and second interfacing portions (110, 120) are configured to engage with one another and are moveable from a first engaged position (when the first and second interfacing portions (110, 120) are engaged to one another) to the second interlocked position (when the first and second interfacing portions (110, 120) are locked to one another). Movement to the second position engages the locking means (130) to securely interlock the first and second interfacing portions (110, 120) together.

Movement from the first engaged position to the second interlocked position, moves the locking protrusions (131) away from alignment with the receiving protrusions (141). The locking means (130) located on the first axial projection (115) is moved in a manner to frictionally abut and contact with an external surface on the functional lip (128) to securely interlock both the articles to one another. The locking protrusions (131) frictionally abutting the second interfacing portion (120) promotes stress along the circular member (117) of the first axial projection (115) of the first interfacing portion (110) and creates a resulting centric force along the second axial projection (125) of the second interfacing portion (120). The cumulative force provides a secure connection in both vertical and horizontal planes, respectively interlocking the articles both axially and laterally.

When in the second interlocked position, the cylindrical taper (126) located directly above the functional lip (128) of the second axial projection (125) and acts in a contingent manner in conjunction with the locking protrusions (131) to mitigate oscillations that may travel through surfaces and articles.

Abutment means can be also included on the interlocking system (100) of the present invention to provide a user with an indication that the interlocking system has been optimally interlocked in the second interlocked position.

Abutment means may provide haptic feedback to the user that the interlocking system has been optimally interlocked in the second interlocked position and can be in the form of an abutment member (151) or a knurled surface (152).

Abutment members (151), may also be included in the interlocking system (100) of the present invention, as shown in FIGS. 5 & 6. The abutment members (151) are in the form of prominences (e.g. bumps, lump, or mounds) which protrude out externally at any position along the second axial projection in between the receiving protrusions (141). Abutment members (151) provide an indication to the user that the interlocking system has been optimally engaged in the second interlocked position.

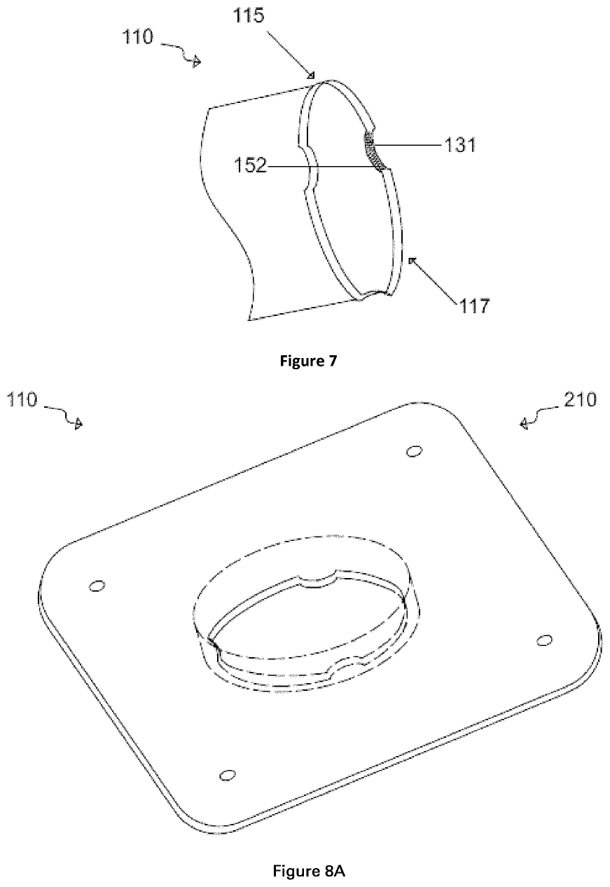

Knurled surfaces (152) may also be included in the interlocking system (100) of the present invention, as shown in FIG. 7. The knurled surfaces (152) can be located on either an internal face of the locking protrusions (131) or an external face at any point along the second axial projection (125) that is used for frictional abutment. Knurled surfaces (152) also provide indication to the user that the interlocking system has been optimally engaged in the second interlocked position.

The interlocking system (100) further includes a visual aid (160), as shown in FIGS. 1B & 2B, to provide the user with an indication the interlocking system has been positioned correctly in the first or second positions.

The visual aids (160) may include markings, or the like (eg. differences in colouration, labels, pattern or integrated design) along the first and/or second interfacing portions (110,120) and/or their respective articles to allow the user to recognise the articles are in the first engaged or second interlocked position from a distance.

It will be appreciated by the person skilled in that art that the interlocking system (100) as shown in FIGS. 1-7 can be adapted to have a ‘reverse’ configuration wherein the locking/receiving protrusions extend outwardly (rather than inwardly as shown in the figures). In this configuration, the same rotational movement to the second interlocked position will engage the locking protrusions in a manner to frictionally abut and contact with a surface of the corresponding interfacing portion.

Further, it will be appreciated that the interlocking system (100) may include attachment portions (210, 220, 230, 240, 250) in order to retrospectively attach or incorporate the interlocking system (100) onto existing articles. Attachment portions (210, 220, 230, 240, 250) include a mounting base which can be suitably sized and configured to work in combination with the particular article. It is envisaged that the mounting base can be adapted or configured to conform to an external surface of the article.

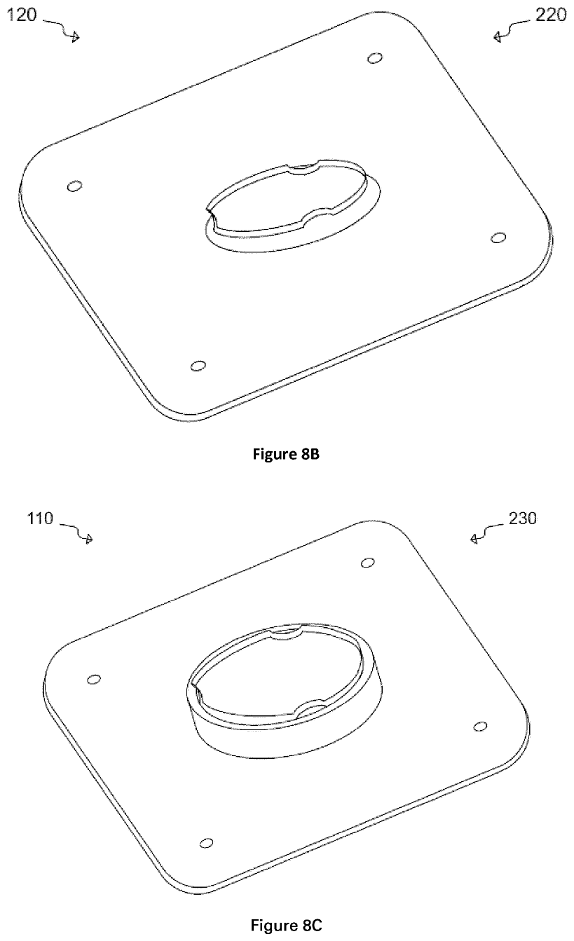

The mounting base of the attachment portions (210, 220, 230, 240, 250) includes a substantially planar base with either the first or second interfacing portions (110,120) located at or near a central portion of the mounting base. It will be understood that ‘pairs’ of attachment portions (210, 220, 230, 240, 250) having a first and second interfacing portions are to be used in combination to retrospectively apply the interlocking system of the present invention onto existing articles. FIGS. 8-10 show variations of attachment portions (210, 220, 230, 240, 250) with provisions for mounting onto existing articles.

With reference to FIG. 8A, a recessed flange mounting variation (210) is shown. Where space on the article permits, the interfacing portion (110 or 120) is recessed on the attachment portion (210).

With reference to FIG. 8B, a surface mount flange variation (220) is shown. The interfacing portion (110 or 120) is substantially flush with the attachment portion (210), with only the corresponding axial projection protruding out from the surface.

With reference to FIG. 8C, a projected flange mount variation (230) is shown. The interfacing portion (110 or 120) sits a distance above the attachment portion (210), with the corresponding axial projection protruding out evenly from the surface. This variation may be used to provide greater access to the interfacing portion where space is limited on the article.

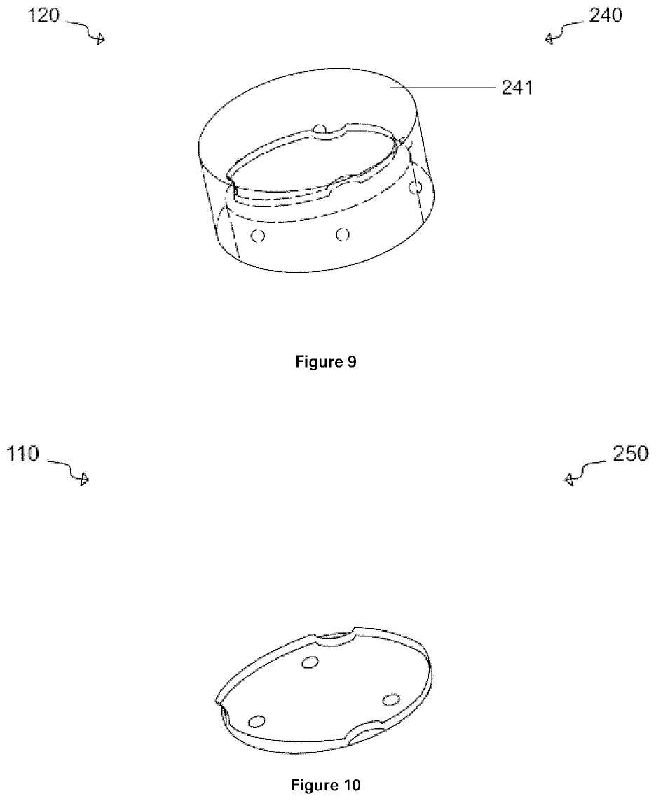

With reference to FIG. 9, an encompassing mount variation (240) (with an external guard projection (241)) is shown. This variation may be used to protect the interfacing portion from unintentional impact.

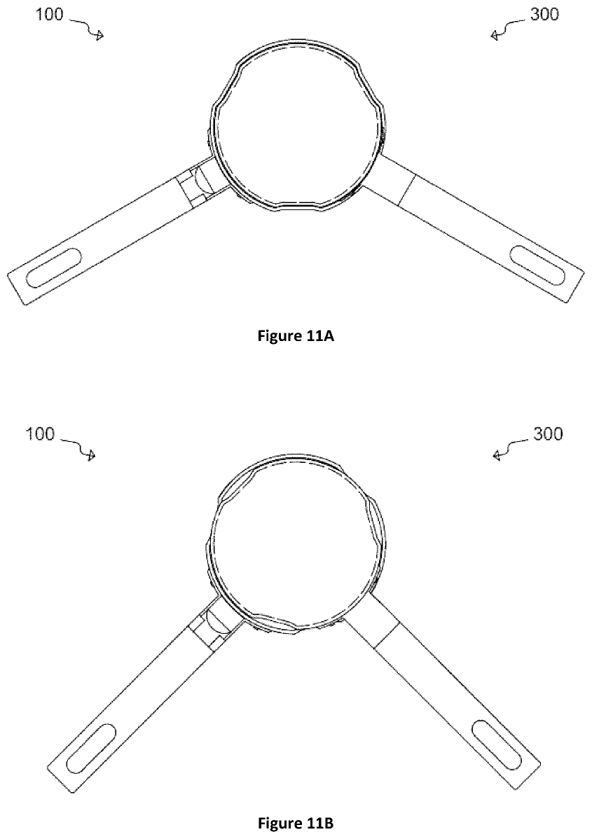

With reference to FIG. 10, a surface mounted variation (250) is shown. This variation includes provisions for mounting the attachment portion in the centre.

It will be appreciated by the persons skilled in the art that while different features for attachment portions (210, 220, 230, 240, 250) have been illustrated in the figures, any number variations of form and plurality of mounting holes, may be included on the interlocking system (100) without departing from the spirit or scope of the invention.

It will further be appreciated by persons skilled in the art that features showcased in the attachment portions (210, 220, 230, 240, 250) may further be included to other articles or applications without departing from the initial spirit or scope of the invention.

It will be appreciated by the persons skilled in the art that while three pairs of locking protrusions/receiving protrusions have been illustrated in the figures, any number of locking protrusions/receiving protrusions may be included on the interlocking system without departing from the spirit or scope of the invention.

It will further be appreciated by the persons skilled in the art that while abutment means have been illustrated in the figures as abutment members and knurled surfaces, other methods of haptic feedback may be employed to indicate an interlocked relationship between two articles without departing from the spirit or scope of the invention.

It will further be appreciated by persons skilled in the art that features used to create abutment means can vary in plurality, form and size without departing from the spirit or scope of the invention.

It will also be appreciated that the interlocking system (100) can be used and adapted on a variety of applications to secure at least two articles to one another. A number of such applications will be discussed below, however the following examples should not be seen as limiting the present invention to such applications in any way.

In a first application, the interlocking system may be applied to containers, in particular tin containers comprising foodstuffs. Such tin containers are widely known and used in industry for storage/packaging of a variety of food products. The tin containers are substantially cylindrical in shape having a top rim and bottom rim. Certain tin containers include rims which are configured to be nestable, or stack with respect to one another other.

It will be appreciated that the interlocking system (100) of the present invention can be incorporated to the tin containers during the manufacture/production of the cans itself. Or alternatively, the interlocking system can be retroactively applied onto existing tin containers by a suitable tool, device or process. As the container is made from a malleable material, the tool or device can be pre-configured to include the locking and reciprocating means (130, 140) along the top and bottom rims (corresponding to the interfacing portions (110,120)) of the container.

Further, it will be appreciated that the interlocking system (100) can be used on the same or different tin canned products as a distributor or manufacturer wishes. It may be used to combine two or more different tinned products as a single combined unit for marketing and selling purposes. This provides advantages to a manufacturer or retailer wishing to combine products together for promotional purposes without requiring any additional unnecessary production steps or costs.

In such an application, it will be appreciated that the articles may also be configured to include assurance means to provide assurance to a user that the integrity of the contents in the container is not compromised. Examples of suitable assurance means include an edible adhesive, a film, barrier layer or a visual marker or the like; which are configured to produce a warning sign or signal if the container has been tampered or compromised in any way.

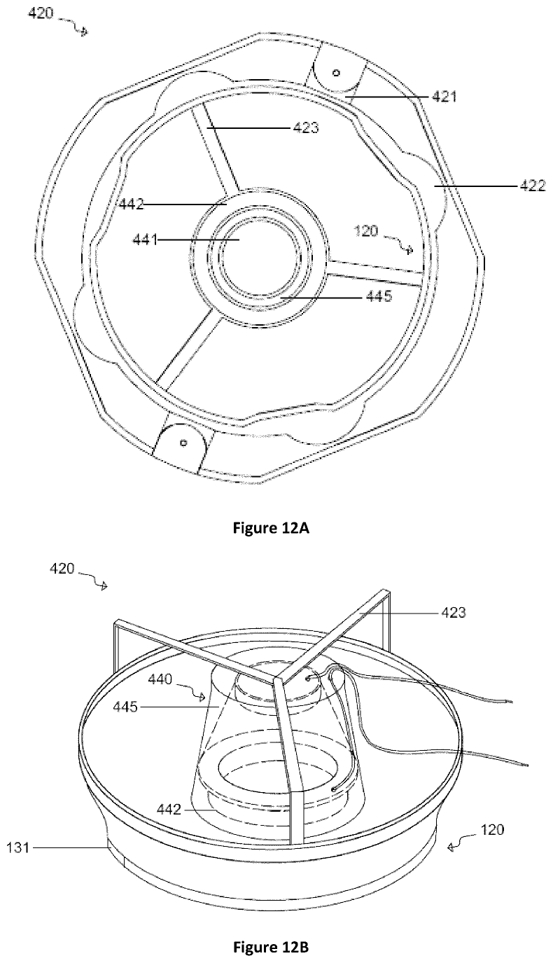

In a further application, the interlocking system can be applied to general household cookware items such as pots and pans etc. For example, as shown in FIGS. 11A-11B, the interlocking system can be included on a pair of frying pans (300) to combine or lock two or more pans to one another.

The interlocking system having the first interfacing portion (110) on a first fry pan, with the second interfacing portion (120) located on a second fry pan.

The interlocked fry pans allow for easy contained flipping of the assembled unit to assist in forming a patty shaped assembly by removing the flipping of the patty itself and promoting the searing of both sides during cooking.

In a further application, the interlocking system (100) can be applied to fixtures, in particular, general household fixtures such as a lighting fixture.

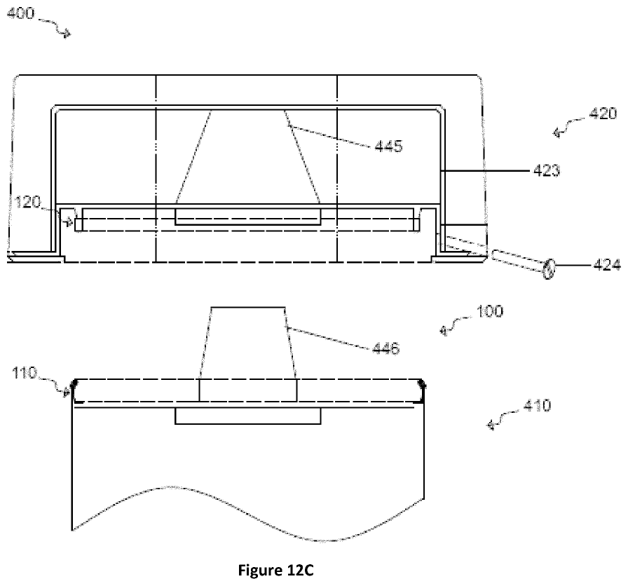

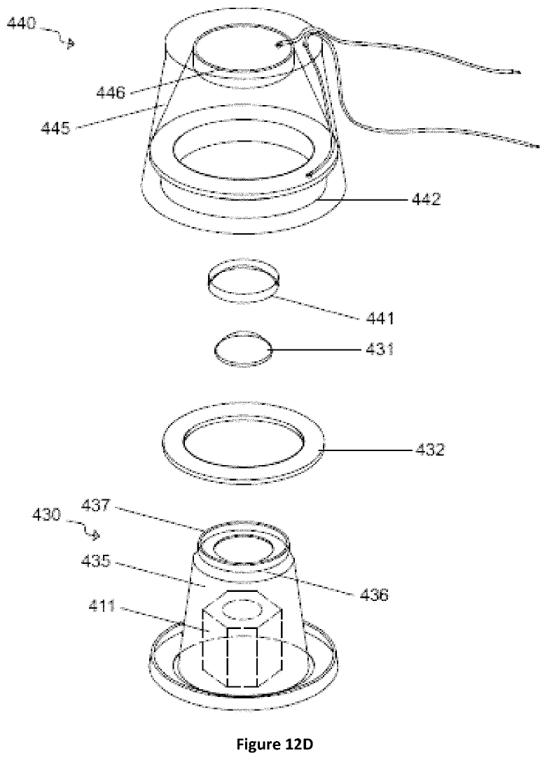

With reference to FIGS. 12A-12D, the application of the interlocking system (100) of the present invention as incorporated into a lighting system (400) is shown.

In FIGS. 12A and 12B, the second interfacing portion (120) of the present invention is incorporated into a lighting fixture mount. The lighting fixture mount is shown in the form of a retroactively applied adapter (420) which can be mounted to an existing electrical fitting, commonly known as an octagon box. The octagon box is a junction box used to make electrical connections and mount electrical fixtures. An octagon box is commonly recessed into a ceiling or a wall. The retroactively applied adapter (420) mounted to an octagon box through the use of wings (421). Spacers (422) are used to keep the retroactively applied adapter (420) centred in the octagon box.

Electrical components incorporated into the interlocking system (100) of the present invention as it applies to a lighting system (400) includes a line side assembly (440) comprising of contacts (441, 442) mounted on a moulded insulator (445) and a load side assembly (430) of contacts (431, 432) mounted on a moulded insulator (435).

The method of suspension (423) of the line side assembly (440) centred in the second interfacing portion (120) can also be seen in FIGS. 12A-12C. The suspension method (423) may be further re-enforced, however it will be appreciated that the hollow space is intentional to allow Electricians to make wiring connections.

The incorporation of the interlocking system (100) of the present invention into the lighting system (400) includes a retroactively applied adapter (420) mounted in the octagon box and an attachment (410) to the lighting fixture. The attachment (410) includes the load side assembly (430) and a first interfacing portion (110). Additionally, the use of one or more set screws (424) used to set the fixture in an optimal position.

With reference to FIG. 12D, a combination of conductors and insulators used to accomplish the completion of the electrical circuit is shown. The conductors are in the form of contacts (441, 442, 431, 432), conductive plasticizer (e.g. solder) and wires; while the insulators are in the form of a moulded former to accommodate the contacts (441, 442, 431, 432) in sub assembly. The line side assembly (440) and load side assembly (430) are configured in complement to one another in order for the line side assembly (440) to receive the load side assembly (430) in a safe manner.

The combination of conductors and insulators is configured in such a way to ensure that a short circuit cannot take place and provides an additional safety feature. The load side assembly's (430) first point of contact (431, 437) cannot bridge either active/neutral and/or active/earth. This arrangement is accomplished by placing the line side assembly's (440) neutral conductor contact (442) and the load side assembly's (430) active conductor contact (431) both in recess to their respective moulded insulators (435, 445).

This arrangement is further accomplished by the use of an external guarding projection (437) being included in the shape of the load side moulded insulator (445) and prevents the de-energized load side active contact (431) from coming into contact with the line side neutral contact (442).

The diameter of the load side active contact (431) and its associated external guarding projection (437) to be less than the space between the line side assembly (440) and any point along the interfacing portion (120).

The line and load side active contacts (441, 431) are further respectively convexly and concavely shaped to facilitate the reception of the load side assembly (430) into the line side assembly (440). The active electrical connection is further facilitated by the embedding of a helical compression spring (not shown) between the line side active contact (441) and the ceiling (446) of the line side assembly's moulded insulator (445). The spring (not shown) creates a force that ensures a tight electrical connection when the contacts are mated. The spring (not shown) mitigates any arcing during the initial mating of the contact sets and provides a reciprocating force to that of the interlocking system (100) of the present invention.

The load side further contains a nut (411) embedded in the load side moulded insulator (435). The nut (411) allows for a conventional type of lighting fixture, commonly known as a dome light, to incorporate the interlocking system (100) of the present invention in a lighting system application (400). The nut (411) receives a threaded stem that is used to support a protective transparent cover that serves the purpose of diffusing the light and protecting the lamps from impact. The stem cannot thread into the load side active contact (431) as it abuts the ceiling (436) of the moulded insulator (435) that the load side active contact (431) is placed on. The dome fixture may be fitted with a first interfacing portion (110) and load side assembly (445) to incorporate the dome fixture into the lighting system (400).

When the interlocking system (100) of the present invention is used in a lighting fixture application (400) the fixture (410) (which as previously stated contains the first interfacing portion (110) and the load side assembly (430)) is pushed up into the retroactively applied adapter (420) (which as previously stated contains the second interfacing portion (120) and the line side assembly (440)) in order to attach or exchange a lighting fixture. The upward force is countered by the spring (not shown) between the line side active contact (441) and the ceiling (446) of the moulded insulator (445) when the receiving protrusions (141) are aligned with the locking protrusions (131) in the first engaged position.

The upward force is maintained while the fixture (410) is moved into the second interlocked position to the point of optimal engagement. The upward force is then released, setting the fixture in the optimally interlocked position. Set screws (424) are used to further fix the fixture (410) in the optimally interlocked position.

The contacts (431, 432) are connected through a plasticized material (e.g. solder) and wires through the fixture to commercially available light sockets in order to accept lamps.

It will be appreciated by persons skilled in the art that while the interlocking system (100) of the present invention as incorporate into a lighting system (400) shows a retroactively applied adapter (420) specific to an octagon box fitting as illustrated in the drawings that the retroactively applied adapter (420) can be incorporated directly into any fitting without departing from the initial spirit or scope of the invention.

It will be appreciated by persons skilled in the art that while the interlocking system (100) of the present invention as incorporate into a lighting system (400) shows a singular form of the electrical contacts as illustrated in the drawings that the form of said contacts is not taken as limiting, as other combinations of form regarding conductors and insulators may provide the same or comparable level of safety without departing from the initial spirit or scope of the invention.

It will be appreciated by persons skilled in the art while the interlocking system (100) of the present invention as incorporate into a lighting system (400) shows no earth connection directly to the fixture itself that it can be added or permitted to be sufficient through the connection of interfacing portions (sometimes called a ‘scarping earth’) should the local electrical safety authority permit this connection without departing from the initial spirit or scope of the invention.

It will be appreciated by persons skilled in the art that while the interlocking system (100) of the present invention as incorporate into a lighting system (400) shows only one helical compression spring between the active contact (441) and the line side moulded insulator (445) ceiling (446) as referenced in the description that an additional helical spring may be added to the neutral contact (442) without departing from the initial spirit or scope of the invention.

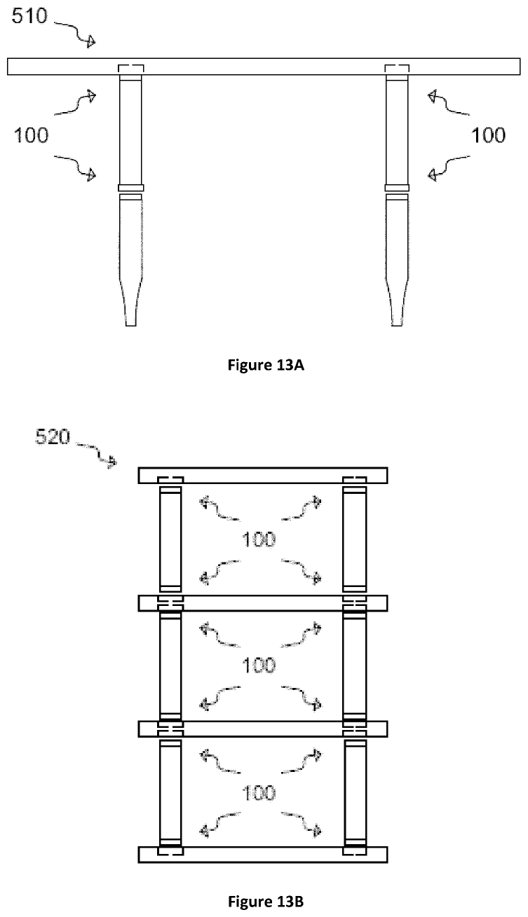

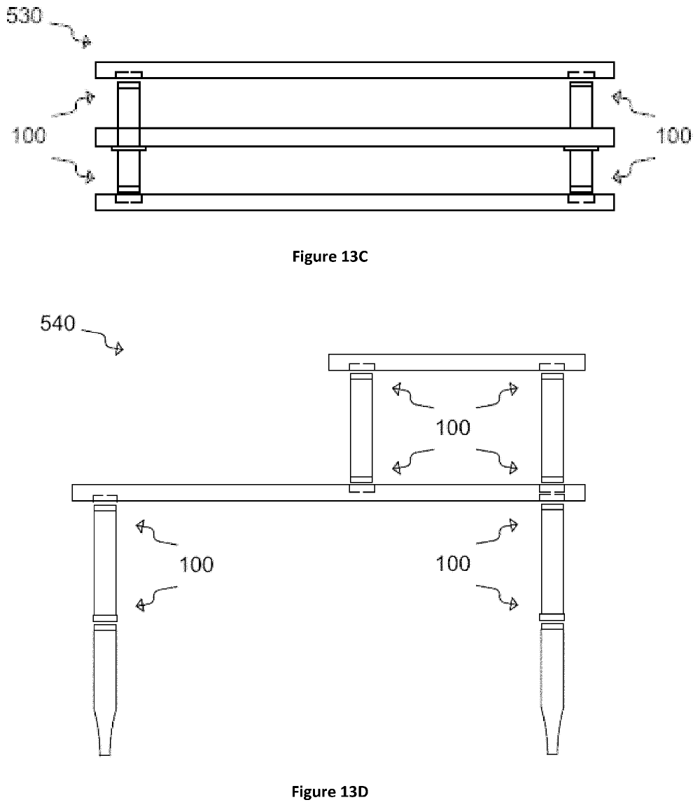

In a further application, the interlocking system (100) can be applied to general household furniture. As shown in FIGS. 13A-13D, the interlocking system (100) of the present invention can be included furniture, in particular, furniture such as a table (510) as shown in FIG. 13A, shelving units (520, 530) as shown in FIGS. 13B & 13C or desk (540) as shown in FIG. 13D. It is envisaged that the interlocking system (100) can also be conveniently applied to modular or kit-set furniture or the like.

The interlocking system (100) can be incorporated to connect a number of components on modular or kit-set furniture. It will be appreciated that typically kit-set furniture packages come with a variety of components to assemble along with comprehensive instructions on how to assemble the furniture. It is envisaged that using the interlocking system of the present invention will greatly reduce the number of components or parts required to assemble the furniture. Parts such as screws and bolts may be replaced with the interlocking system (100) of the present invention. This provides advantages in cost savings and reduces the number of components required, as well as simplifying the overall assembly process for the user.

### Alternative Embodiment

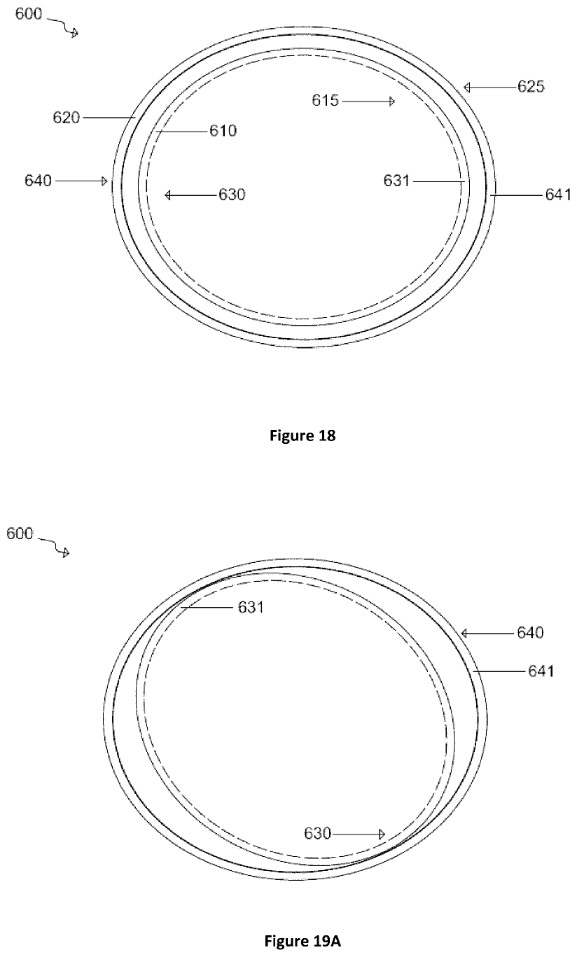

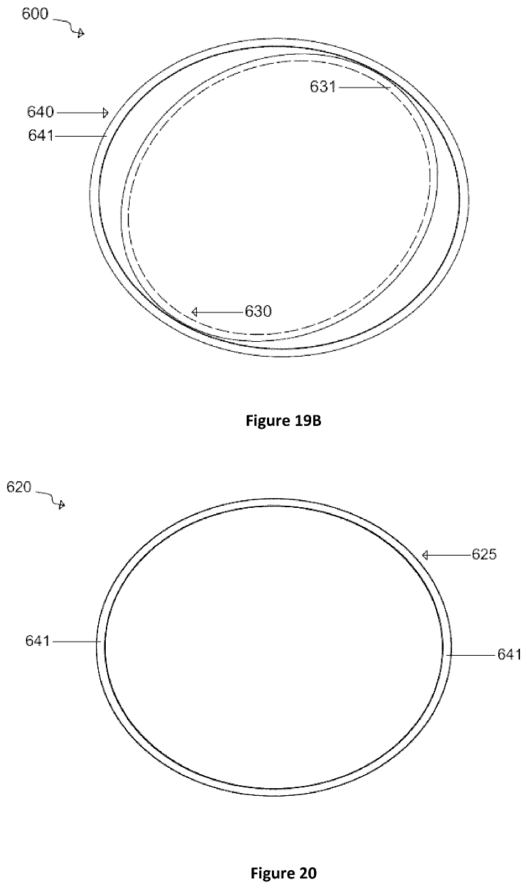

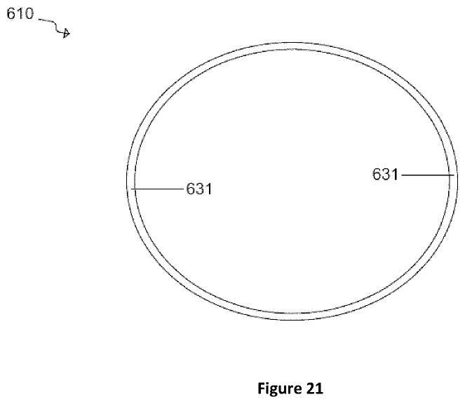

With reference to FIGS. 16-21 which shows the various components of an alternative embodiment of a detachable interlocking system (600) of the present invention. The interlocking system (600) exhibits similar functionality and operation as the interlocking system (100) described above. Where appropriate, the interlocking system (600) employs the same or similar component naming convention as the interlocking system (100) above; any differences in the component description of the interlocking system (600) will be further described below.

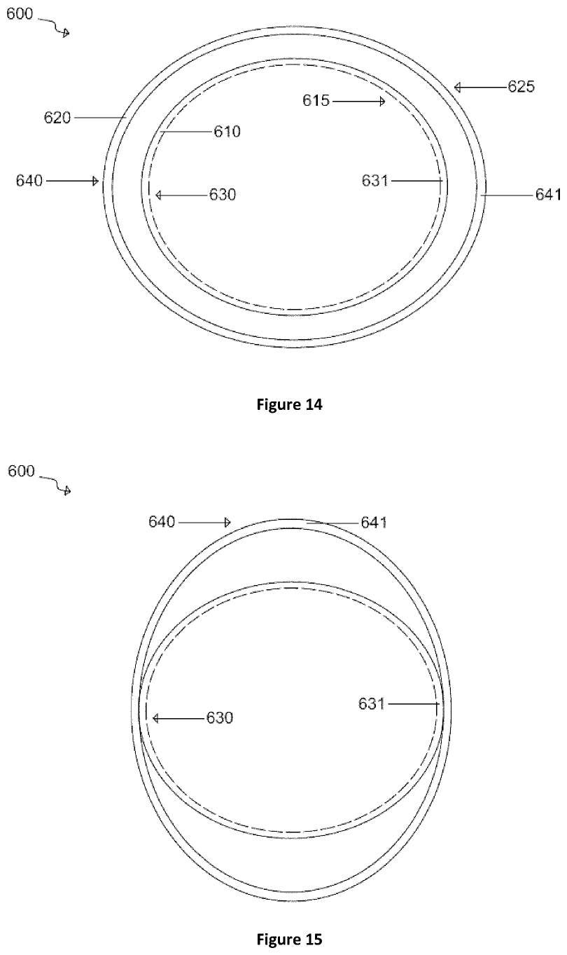

In an alternative embodiment, the interlocking system (600) includes first and second interfacing portions (610, 620). The first and second interfacing portions (610, 620) each include a corresponding axial projection (615, 625) as shown in FIGS. 14 & 18, which extends out from at least one external face of the respective article (not shown). The first interfacing portion (610) consists largely of an axial projection (615) which comprises of a cylindrical taper (not shown) and a substantially circular member (not shown), the second interfacing portion (620) consists of an axial projection (625) which comprises of a substantially circular member (not shown).

The interlocking system (600) includes locking means (630) located on the first axial projection (615) of the first interfacing portion (610). The locking means (630) includes locking protrusions (631), which arise from gradual elongations of the substantially circular member (not shown) of the first axial projection (615) and are largely indistinct, said protrusions are shown in FIGS. 17 & 21.

Reciprocating means (640) are also included on the interlocking system (600) and are located on the second axial projection (625) of the second interfacing portion (620). The reciprocating means (640) is configured to receive and accommodate the locking means (630) in the first engaged position.

The reciprocating means (640) is included in the form of complimentary receiving protrusions (641) which arise form gradual elongations of the substantially circular member (not shown) of the second axial projection (625) and are largely indistinct, as shown in FIGS. 16 & 20. The first and second interfacing portions (610, 620) are configured to complement one another and receive each other such that the articles on which the respective interfacing portions are on have a nestable or stackable arrangement.

The first and second interfacing portions (610, 620) are able to move from a first engaged position to a second interlocked position. Movement from the first engaged position to the second interlocked position engages the locking means (630) to interlock the first and second interfacing portions (610, 620) with one another. Movement between these two positions can be done by rotation/twisting of adjacent articles in either direction, i.e. clockwise or anti-clockwise, providing said movement occurs in relative opposing axial directions. Further continued movement of the articles in the same respective direction may disengage the locking means and release the articles to the first engaged position. Alternatively, disengaging the locking means can also be done by movement in the opposing direction to that which is used to move to the second engagement position.

Movement from the first engaged position to the second interlocked position, moves the locking protrusions (631) away from alignment with the receiving protrusions (641). The locking means (630) located on the first axial projection (615) is moved in a manner to frictionally abut and contact with an internal surface on the circular member (not shown) to securely interlock both the articles together.

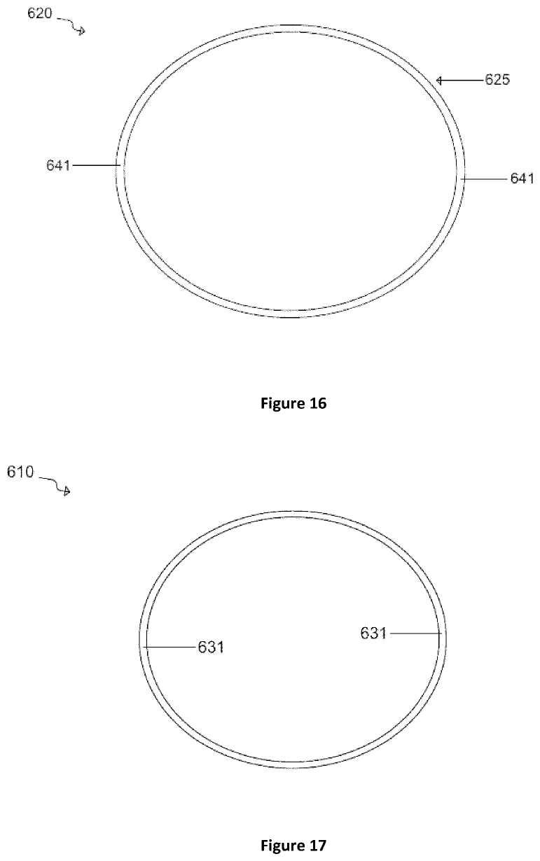

FIGS. 15, 19A & 19B further illustrates how differences in the relative sizing between the first and second axial projections (615, 625) result in different second interlocked positions. Abutment means (not shown) can be included on the interlocking system (600). FIGS. 15, 19A & 19B additionally illustrate an alternate form of frictional abutment; wherein a singular abutment member can be added in order to achieve a comparable user experience to that shown in FIGS. 5A & 5B of the interlocking system (100) described above.

It will be appreciated by the persons skilled in the art that the interlocking system (600) is applicable but not limited to the same applications as the interlocking systems (100) above. It will further be appreciated by person skilled in the art that the interlocking system (600) may include complementary attachment portions (not shown) in the same variety as the interlocking system (100). And that features illustrated in said attachment portions may be included in either interlocking systems (100, 600) of the present invention.

It will yet further be appreciated by persons skilled in the art that further embodiments which incorporate features from the interlocking system (100) in the present alternative embodiment does not depart from the spirit or scope of the present invention. And will it still yet further be appreciated by person skilled in the art that the interlocking system (600) may include the same means and attributes of the interlocking system (100).

Unless the context clearly requires otherwise, throughout the summary, description and the claims, the words “comprise”, “comprised”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

What I/we claim is:

1. A detachable interlocking system for securing at least two articles together, the interlocking system including:
i. a first interfacing portion;
ii. a second interfacing portion;
the first and second interfacing portions being in a complementary arrangement configured to engage with one another in a first engaged position and are moveable to a second interlocked position;
the first and second interfacing portions each respectively include a first and second substantially circular axial projection extending out from at least one external surface of the article;
iii. locking means to interlock the first and second interfacing portions together;
iv. reciprocating means to receive and accommodate the locking means;
the locking means including at least one locking protrusion from the substantially circular axial projection of the first interfacing portion;
wherein movement from the first engaged position to the second interlocked position engages the locking means to interlock the first and second interfacing portions together;
the locking means being engaged by way of the locking protrusion frictionally abutting a face of the substantially circular axial projection of the second interfacing portion.

2. A detachable interlocking system as claimed in claim 1, wherein the first and second interfacing portions are both included on each article.

3. A detachable interlocking system as claimed in claim 1, wherein the first and second interfacing portions are included on two different articles.

4. A detachable interlocking system as claimed in any one of claims 1-3, wherein the first and second interfacing portions each include an attachment portion to retrospectively incorporate and apply the detachable interlocking system on to existing articles.

5. A detachable interlocking system as claimed in any one of claims 1-4, wherein the substantially circular axial projections are composed of a pliable material or the like.

6. A detachable interlocking system as claimed in any one of claims 1-5, wherein one interfacing portion is of a size larger than the other interfacing portion to allow the first and second interfacing portions to be nestable within one another.

7. A detachable interlocking system as claimed in any one of claims 1-6, wherein the reciprocating means is configured to complimentarily receive the locking means and said at least one locking protrusion in the first engaged position.

8. A detachable interlocking system as claimed in any one of claims 1-7, wherein the locking means is located on the first interfacing portion.

9. A detachable interlocking system as claimed in any one of claims 1-8, wherein the reciprocating means is located on the second interfacing portion.

10. A detachable interlocking system as claimed in any one of claims 1-9, wherein the reciprocating means includes at least one complementary receiving protrusion inset from the substantially circular axial projection of the second interfacing portion.

11. A detachable interlocking system as claimed in any one of claims 1-10, wherein the movement from the first engaged position to the second interlocked position is by way of rotational movement of the first and second interfacing portions in relative opposing axial directions.

12. A detachable interlocking system as claimed in any one of claims 1-11, wherein the movement from the first engaged position to the second interlocked position is by way of rotational movement in either clockwise or anti-clockwise directions.

13. A detachable interlocking system as claimed in any one of claims 6-12, wherein the locking protrusion frictionally abutting said face of the interfacing portion results in the larger interfacing portion flexing when in the second interlocked position.

14. A detachable interlocking system as claimed in claim 13, wherein the flexing of the larger interfacing portion results in a concentration of force on the smaller interfacing portion to restrict movement in the second interlocked position.

15. A detachable interlocking system as claimed in any one of claims 1-14, wherein the locking means includes at least three locking protrusions located along the substantially circular axial projection of the first interfacing portion.

16. A detachable interlocking system as claimed in claim 15, wherein the three locking protrusions are equally spaced along the substantially circular axial projection of the first interfacing portion.

17. A detachable interlocking system as claimed in any one of claims 1-16, wherein the reciprocating means includes at least three complementary receiving protrusions located on the substantially circular axial projection of the second interfacing portion.

18. A detachable interlocking system as claimed in claim 17, wherein the three receiving protrusions are equally spaced along the substantially circular axial projection of the second interfacing portion.

19. A detachable interlocking system as claimed in any one of claims 1-18, wherein the interlocking system further includes abutment means to provide an indicator in the form of haptic feedback to the user that the interlocking system is interlocked or optimally interlocked in the second position.

20. A detachable interlocking system as claimed in claim 19, wherein the abutment means includes at least one abutment member and/or a knurled surface or a combination thereof.

21. A detachable interlocking system as claimed in claim 20, wherein the abutment member is a prominence located along the substantially circular axial projection of the second interfacing portion.

22. A detachable interlocking system as claimed in any one of claim 20 or 21, wherein the knurled surface is located along either the first or second substantially circular axial projection.

23. A detachable interlocking system as claimed in any one of claims 1-22, further including a visual aid to allow the user to recognise the articles are in the first engaged or second interlocked position from a distance.

24. A detachable interlocking system as claimed in claim 23, wherein the visual aid includes markings along the first and second interfacing portions and/or their respective articles.

25. A detachable interlocking system as claimed in any one of claims 1-24, wherein the articles are selected from containers, household items, fixtures, equipment, kit set furniture and/or combinations thereof.
